(19) United States
(12) Patent Application Publication
(10) Pub. No.: US 2006/0020802 A1
(43) Pub. Date: Jan. 26, 2006

(54) Tonal compensation for graphic security features

(75) Inventors: Bertrand Haas, New Haven, CT (US); Donald G. MacKay, Roxbury, CT (US); Claude Zeller, Monroe, CT (US)

Correspondence Address: Pitney Bowes Inc.;Intellectual Property & Technology Law Department, 35 Waterview Drive, P.O. Box 3000, Shelton, CT, 06484, US

(73) Assignee: Pitney Bowes Incorporated, Stamford, CT (US)

(21) Appl. No.: 10/897,716

(22) Filed: Jul. 23, 2004

(51) Int. Cl. H04L 9/00

(52) U.S. Cl. 713/176

(57) ABSTRACT

A printed image includes a plurality of sample gray scale regions. A method of determining authenticity of the printed image includes scanning the printed image to produce pixel data that corresponds to the printed image. A gray scale level is detected for each of a plurality of subsets of the pixel data. Each subset corresponds to a respective one of the sample gray scale regions. The detected gray scale levels are used to define an inverse transformation, which is applied to the pixel data. The inverse-transformed pixel data is processed to detect a security feature of the printed image.

### BACKGROUND

This invention relates generally to the field of printed document security, and more particularly, to improved examination of documents for authenticating the same.

It has been proposed to include watermarks or other security features in printed documents. The documents thereafter may be scanned and the resulting pixel data analyzed to detect the security features to determine whether the scanned documents are authentic originals.

However, the document examination process may be disrupted, possibly resulting in “false positives” (false indications that authentic documents are not authentic), as a result of various factors. For example, a considerable period of time may elapse after the document is printed and before it is examined. During this time, effects of aging may change one or both of the ink tone and the background paper tone. Exposure to environmental conditions such as bright light may similarly work changes in ink and/or paper tone. In either or both cases, gray scale levels detected upon examination of the printed image may be shifted from the pixel values used in the printing operation and/or may be shifted from the gray scale levels expected to be produced by the printing operation. Moreover, deviations from expected performance by either or both of the printer which produced the document or the scanner used in examining the document may also result in shifting of detected gray scale levels from the expected levels.

Shifting of gray scale levels from expected levels, whatever the cause of the shifting, may interfere with detection of security features in a document under examination. Where so-called “fragile watermarks” are present in the document, the effects of aging, etc. may erode the watermark, leading to a false conclusion that the document is a copy in cases in which the document is, in fact, an original. Such false results may compromise the document security scheme.

Therefore, it would be desirable to provide a document authentication system which can overcome or ameliorate the effects of shifting of detected gray scale levels which results from some or all of the causes described above.

### SUMMARY

Accordingly, methods are provided to allow for compensation for shifts in detected gray scale levels in connection with authentication of printed documents.

In one aspect, a method of determining authenticity of a printed image includes scanning the printed image. The printed image includes a plurality of sample gray scale regions and the scanning produces pixel data that corresponds to the printed image. The method further includes detecting a gray scale level of each of a plurality of subsets of the pixel data. Each of the subsets corresponds to a respective one of the sample gray scale regions. The method also includes using the detected gray scale levels to define an inverse transformation (e.g., by interpolation), applying the inverse transformation to the pixel data, and processing the inverse-transformed pixel data to detect a security feature of the printed image.

The security feature may be a watermark. The plurality of sample gray scale regions may include three regions, each having a different gray scale level from the other regions. The sample gray scale regions may be in the form of a sequence of rectangular regions, and the inverse transformation may be represented in the form of an inverse look-up table. The printed image may be part of a postage meter indicium.

In another aspect, a method of determining authenticity of a printed image includes providing first pixel data representative of a security feature included in the printed image and scanning the printed image. The printed image includes a plurality of sample gray scale regions, and the scanning produces second pixel data that corresponds to the printed image. The method further includes detecting a gray scale level of each of a plurality of subsets of the second pixel data. Each of the subsets corresponds to a respective one of the sample gray scale regions. The method also includes using the detected gray scale levels to define a transformation, applying the transformation to the first pixel data, and comparing the transformed first pixel data to a portion of the second pixel data.

The security feature may be a watermark or a copy detection pattern. The transformation may be represented in the form of a look-up table.

In another aspect, a method includes providing a mailpiece and applying a postage meter indicium to the mailpiece. The indicium includes a pictorial image, a security feature and a sequence of at least three rectangular sample grey scale regions adjacent to the pictorial image. Each sample gray scale region has a substantially uniform gray scale tone and each has a respective gray scale level that is substantially different from the other sample gray scale regions.

The applying of the indicium may include printing the indicium on the mailpiece, and the security feature may be a watermark in the pictorial image.

By including gray scale level sample regions in the original image and then determining the detected gray scale levels of the sample regions upon examination, the nature of shifting of detected gray scale levels due to aging, scanner drift, etc. may be detected, and the image examination process may be compensated for the shift in detected gray scale levels. As a result, the reliability of document authentication procedures may be enhanced.

Therefore, it should now be apparent that the invention substantially achieves all the above aspects and advantages. Additional aspects and advantages of the invention will be set forth in the description that follows, and in part will be obvious from the description, or may be learned by practice of the invention. Various features and embodiments are further described in the following figures, description and claims.

### DESCRIPTION OF THE DRAWINGS

The accompanying drawings illustrate presently preferred embodiments of the invention, and, together with the general description given above and the detailed description given below, serve to explain the principles of the invention. As shown throughout the drawings, like reference numerals designate like or corresponding parts.

FIG. 1 is a block diagram that illustrates an apparatus provided in accordance with the invention for printing a watermarked image as part of a postage indicium.

FIG. 2 is a flow chart that illustrates a process that may be provided in accordance with the invention for generating and printing watermarked images.

FIG. 3 is a schematic illustration of a postage meter indicium produced by the apparatus of FIG. 1 and the process of FIG. 2.

FIG. 4 is a block diagram of an apparatus that may be provided in accordance with the invention to examine printed images.

FIG. 5 is a flow chart that illustrates a process that may be provided in accordance with the invention to detect a watermark.

FIG. 6 is a flow chart that illustrates a process that may be provided in accordance with an alternative embodiment of the invention to examine a security feature of a printed image.

### DETAILED DESCRIPTION

In accordance with the present invention, an image to be examined includes sample gray scale level regions printed at different gray scale levels pursuant to predetermined print pixel values. Upon examination of the image, the sample regions are scanned, and the resulting gray scale levels of the scanning pixel values are compared with the original print pixel values to determine how aging or other factors may have shifted the scanning pixel values from the original print pixel values. An appropriate compensation procedure is implemented in connection with the examination of the image to reflect the detected shift in pixel values.

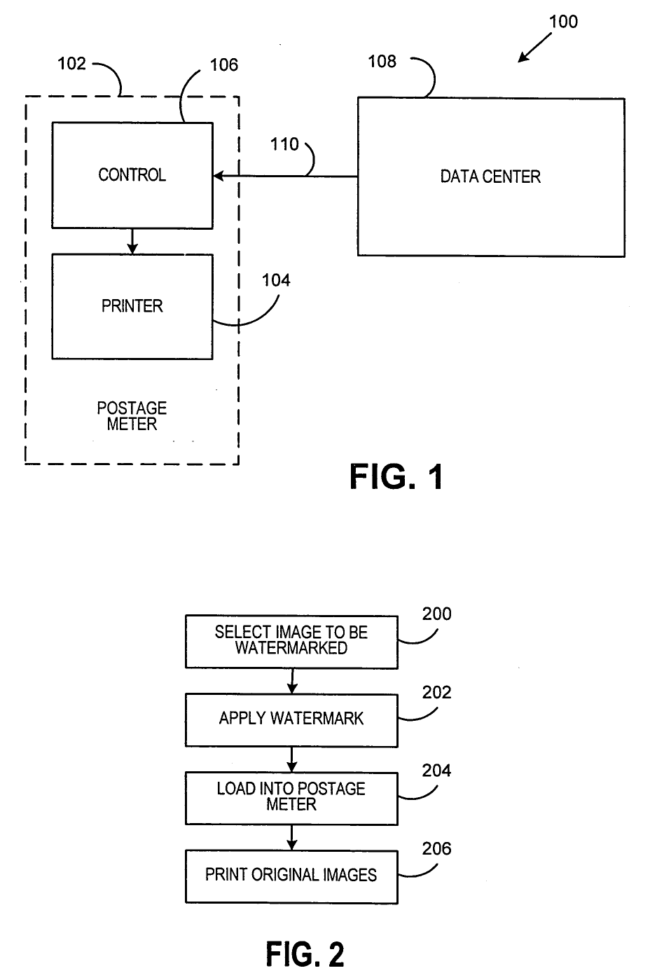

Referring now to the drawings, and particularly to FIG. 1, the reference numeral 100 indicates generally an apparatus for printing watermarked images in accordance with principles of the present invention. The printing apparatus 100 includes a postage meter 102. The postage meter 102, in turn, includes a printer 104 and control circuitry 106 that is coupled to, and controls operation of, the printer 104. (Although embodiments of the present invention are described herein in the context of postage metering, those who are skilled in the art will recognize that the methods of the invention may also be applied to production and verification of other types of secure documents, including paper currency, travel and event tickets, and identification documents.) The printer 104 may be of a type that is capable of printing gray scale images or color images. For example, the printer 104 may include a dye-sublimation printer. In some embodiments, the printer may be capable of printing 256 gray levels.

The printing apparatus 100 also includes a data center 108 that is in communication with the control circuitry 106 of the postage meter 102 via a data communication channel 110. The data center 108 may generate a watermarked image, and may download to the postage meter 102 image data which represents the watermarked image. Using the downloaded image data, the postage meter 102 may print the watermarked image as a part of postage meter indicia applied to mailpieces, which are not shown. Thus the mailpieces, and particularly the postage meter indicia thereon, may constitute original documents which a postal authority may wish to verify.

FIG. 2 is a flow chart that illustrates a process performed in accordance with the invention in the printing apparatus 100 of FIG. 1.

Initially, at step 200, an image is selected for watermarking. In some embodiments the image may be a standard image that is required to be printed as part of every postage meter indicium by every postage meter, or by every postage meter that is part of a program for incorporating a gray scale image in postage meter indicia. In other embodiments, the image may be one of a number of standard images, any one of which may be selected by the lessor of a postage meter as the image to be incorporated in indicia to be printed by the particular postage meter. In still other embodiments, the image may be a gray scale image that is chosen by the lessor of the postage meter from among images available for purchase or licensing, or may be generated by the lessor of the postage meter. In these cases the selected image may be sent by the lessor of the postage meter to the data center for watermarking so that the image can be incorporated in indicia to be printed by the particular postage meter. An image other than a gray scale image may alternatively be used.

In some embodiments, the image to be watermarked may be represented by pixel data that represents, with respect to each pixel of the image, a gray scale level. The number of available gray scale levels may be 256 in some embodiments. In such embodiments, each pixel may be represented by one 8-bit byte of image data, and the value of each pixel may be an integer n, with n greater than or equal to zero and less than or equal to 255. Each value of n may correspond to a different gray scale level; in some embodiments the zero value corresponds to black, the value 255 corresponds to white (no tone), and each value of n corresponds to a tone which is darker than the tone which corresponds to n plus one.

Step 202 follows step 200 in FIG. 2. At step 204 a watermark is applied to the image selected at step 200. In some embodiments, the watermark applied at step 202 may be made by block-wise adjustments in the tone (average gray scale level) in the transformed image data, in a manner described in co-pending, commonly-assigned patent application Ser. No. ______ (Attorney docket no. F-713), which is entitled: “Fragile Watermark for Detecting Printed Image Copies”. This co-pending patent application is hereby incorporated herein by reference in its entirety.

Alternatively, another type of watermark may be applied at step 202. For example, the watermark applied at step 204 may be a phase-space encoded watermark of the type described in co-pending, commonly-assigned patent application Ser. No. ______ (Attorney docket no. F-714), which is entitled: “Detecting Printed Image Copies Using Phase-Space Encoded Fragile Watermark”, or of the type described in co-pending commonly-assigned patent application Ser. No. ______ (Attorney docket no. F-828), which is entitled: “Watermarking Images with Wavepackets Encoded by Intensity and/or Phase Variations”. These co-pending patent applications are hereby incorporated herein by reference in their entirety. Another type of watermark may alternatively be used, including for example any of a wide variety of conventional watermarks. As one example, there may be applied at step 202 the DFT-based watermark described in “Watermarking and Digital Signature Techniques for Multimedia Authentication and Copyright Protection” by Ching-Yung Lin (Ph.D. thesis submitted to Columbia University, 2000). In general, the watermark applied at step 202 may be a “fragile” watermark, as described in the above-referenced co-pending patent applications, or may be a “robust” watermark. Moreover, more than one watermark may be applied at step 204, and the watermarks applied may include both a fragile watermark and a robust watermark.

Both the original data that represents the image to be watermarked and the watermark data itself may be gray scale data. Alternatively, one or both of the original image data and the watermark data may include color information so that the resulting watermarked image may be at least partially in color.

In addition or alternatively, the image may include or have associated therewith a printed security feature other than a watermark. For example, there may be associated with or included in the image a copy detection pattern (CDP) of the type produced by Mediasec Technologies, GMBH, Essen, Germany and described in published international patent application WO 03/098540.

As indicated at 204, the watermarked image data may be loaded into the postage meter 102. For example, the watermarked image data may be downloaded from the data center 108 to the control circuitry 106 of the postage meter 102 via the data communication channel 110. Alternatively, the image data may be copied onto a floppy disk or other transportable data storage medium. The storage medium may then be mailed to the lessor of the postage meter and used to load the watermarked image data into the postage meter.

In any event, once the watermarked image data is present in the postage meter 102, the control circuitry 106 may control the printer 104 to print watermarked images (step 206, FIG. 2), based on the watermarked image data, as part of postage meter indicia applied to mailpieces. It will be appreciated that the printing of the postage meter indicia may include supplying mailpieces and printing the indicia directly on the mailpieces, and/or printing the indicia on stickers or labels to be applied to the mailpieces. Both direct printing of indicia on mailpieces and application on mailpieces of stickers or labels that have indicia printed thereon may be considered to constitute application of indicia to the mailpieces. In some embodiments, the image may be printed at a resolution of 200 gray scale dots (pixels) per inch. The data center may store data indicative of the watermark applied at step 202. The process of generating the data used to drive the printer 104 may also include one or more transformations of the image data (before and/or after watermarking) to compensate for distortions in pixel levels that result from passage through the print-scan “channel”, as described in co-pending, commonly assigned patent application Ser. No. ______ (Attorney docket no. F-745), which is entitled “Watermarking Method with Print-Scan Compensation” and which is incorporated herein by reference.

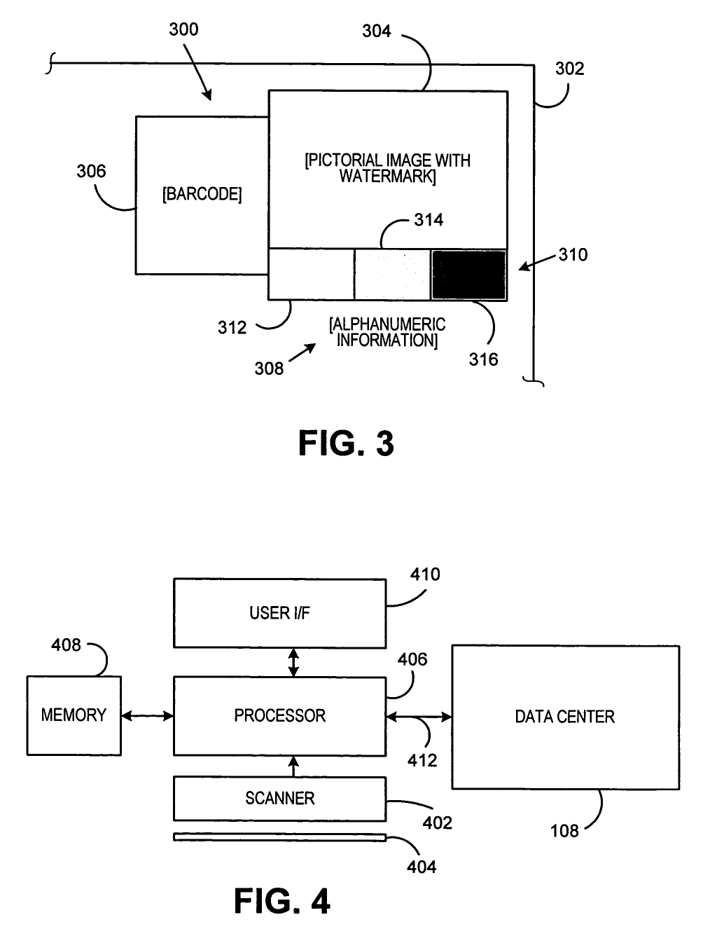

FIG. 3 is a schematic illustration of an example postage meter indicium 300 printed by the postage meter 102 on a mailpiece 302. The postage meter indicium 300 includes a pictorial image indicated schematically at 304. The pictorial image 304 may be a gray scale image that is derived from a photograph, and may include a watermark and/or may include or have associated with it another type of printed security feature. The postage meter indicium 300 may also include, for example, a barcode (schematically indicated at 306) such as the two-dimensional barcode called for by the Information-Based Indicia Program (IBIP) promulgated by the United States Postal Service. Further, in accordance with conventional practices, the postage meter indicium may also include, as indicated schematically at 308, alphanumeric information such as postage amount, date of mailing, meter number, origin zip code, etc.

In addition, in accordance with some embodiments of the invention, the postage meter indicium includes a sequence 310 of rectangular sample gray scale regions 312, 314, 3 16. Each of the sample gray scale regions 312, 314, 316 has a substantially uniform gray scale tone (the tones being represented by degrees of shading in the drawing) that reflects a constant pixel value applicable to all of the pixels in the respective region in the pixel data used to drive the printer 104 to print the indicium 300. It will be noted that the three regions 312, 314, 316 each have respective gray scale levels that are substantially different from the other regions. The respective pixel data levels used to generate the regions may be downloaded to the postage meter 102 from the data center 108 or may be permanently stored in the postage meter at the time of manufacture or on another occasion.

Although it may be desirable for at least three sample gray scale regions to be provided, a larger number such as five or six may alternatively be employed. The regions may be formed in a vertical bar rather than the horizontal bar shown for the sequence 310 in the drawing. The regions need not be arrayed in increasing or decreasing order of lightness/darkness. The regions may be square, or rectangular but not square, or may be any convenient non-rectangular shape. In some embodiments, the sample gray scale regions may be included within, and even hidden within, the pictorial image 304. It may be desirable for the respective gray scale levels of sample regions to be “spaced” along the span of available gray scale levels of the printer 104. For example, if only three regions are provided, it may be desirable for one to be a rather light gray, one a rather dark gray (but not black) and the third at a level about half-way between the first two. Even if located alongside the pictorial image proper, the sample gray scale regions are still to be considered part of the pictorial image.

FIG. 4 is a block diagram of an image examination apparatus 400 that may be provided in accordance with the invention to examine printed images generated in accordance with the procedure of FIG. 2.

The image examination apparatus 400 may include a scanner 402 (e.g., a 600 dpi scanner) to scan a substrate 404 (e.g., a mailpiece such as mailpiece 302, FIG. 3) to generate scanning image data that represents an image (not separately shown in FIG. 4; the image may be the indicium 300 or a subset thereof including the pictorial image 304 and the sequence 310 of sample gray scale regions) carried on the substrate 404. The printed image scanned by the scanner 402 may be referred to as the “printed-image-under examination” or “PIUE”.

The image examination apparatus 400 further includes a processor 406 that is coupled to the scanner 402. The processor 406 may process scanned image data generated by the scanner 402, and may store scanned image data in a memory 408 that is coupled to the processor 404. The memory 408 may serve as a program store and as working memory, as well as a scanned image data store.

The image examination apparatus 400 may further include a user interface 410 which is coupled to the processor 406 to allow an operator of the apparatus to provide input to the processor and to receive output from the processor. In addition, the processor 406 may be temporarily or permanently coupled to a data center (which may be the data center 108 of FIG. 1) via a data communication channel 412.

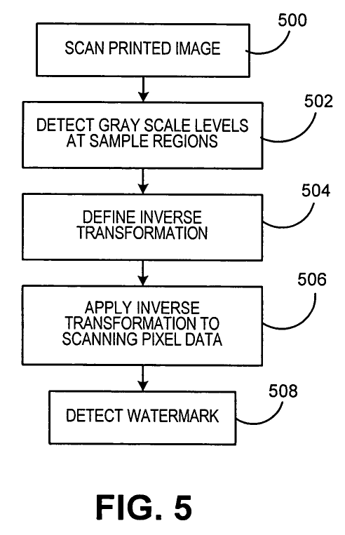

FIG. 5 is a flow chart that illustrates a process that may be performed in accordance with some embodiments of the invention by the image examination apparatus 400 of FIG. 4 to examine a PIUE. The process of FIG. 5 may be suitable, for example, for use in detecting/examining a watermark or other type of printed security feature which does not require comparison with predetermined pixel data. Examples of watermarks which do not require comparison with predetermined pixel data are the fragile watermarks disclosed in the above referenced co-pending patent applications Docket Nos. F-713 and F-714.

According to a first step 500 in the process of FIG. 5, the apparatus 400 scans the PIUE via the scanner 402 to generate scanned image data. The scanned image data is made up of pixel data that may be constituted by gray scale values and represents the PIUE as a set of scanning pixels. The scanned image data may be pre-processed by the processor 406 and/or stored in the memory 408.

Next is step 502, at which the processor 406 analyzes the scanned image data produced at step 500 to detect the gray scale level of each of a plurality of subsets of the scanning pixel data generated by the scanner 402 and/or stored in the memory 408. Each of these subsets corresponds to a respective one of the above-mentioned sample gray scale regions. From these detected gray scale levels, the processor is able to determine the respective shifts in levels in the pixel data for each of the sample regions from the original pixel data used to print the regions to the levels actually detected at the regions by the scanner 402. (The original printing pixel data levels may be provided to the processor 406 by the data center 108, may be stored in the memory 408 upon manufacture of the examination equipment, or may be provided in some other way (e.g., by user input).) Using the detected shifts in gray scale levels, the processor derives a function which translates scanning pixel gray scale levels into corresponding original printing data gray scale levels, as indicated at step 504. This function may be referred to as an inverse transformation and may be produced by interpolating from the, e.g., 3 scanned gray levels to map a pre-transformation set of, e.g., 256 gray-scale levels to a post-transformation set of, e.g., 256 gray scale levels. This may be done by using a known shape of a graph of a gray scale level mapping. The mapping which defines the transformation can take as an input the three parameters represented by the three scanned gray scale levels. (In some embodiments, a forward direction function may first be determined and the inverse transformation may be derived from the forward direction function.) In some embodiments, the inverse transformation may be represented in the examination equipment as an inverse look-up table stored in the memory 408.

Next, as indicated by step 506, the inverse transformation is applied to the scanning pixel data for the pictorial image generated by the scanner 402 and/or stored in the memory 408. For example, an inverse look-up table generated at step 504 may be used to inverse-transform the scanning pixel data. The resulting inverse-transformed pixel data approximates the pixel data originally used to cause the pictorial image to be printed (assuming that the PIUE is an original document/indicium). Then, as indicated by step 508, the processor processes the inverse-transformed pixel data to detect the watermark in the pictorial image. The watermark detection process may employ a conventional process for detecting a watermark, or may be in accordance with the watermark detection procedures described in the above-referenced co-pending, commonly-assigned patent applications. The inverse transformation of the scanning pixel data applied at 506 may aid in preventing original images from being misidentified as copies by the examining apparatus, notwithstanding shifts in the detected gray scale levels due to aging or exposure of the printed image to environmental conditions prior to examination and/or due to variations in performance by the printer 104 or the scanner 402.

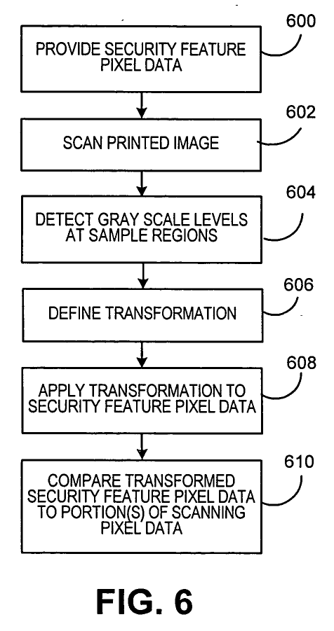

FIG. 6 is a flow chart that illustrates a process that may be provided in accordance with another alternative embodiment of the invention. The process of FIG. 6 may be suitable, for example, for use in detecting/examining a printed security feature which requires comparison with predetermined pixel data. A CDP, as referred to above, is an example of such a printed security feature.

Initially in FIG. 6, as indicated by step 600, the examining apparatus receives from the data center 108 or otherwise stores original pixel data which represents data used to drive the printer 104 to print a security feature such as a CDP. Next, according to step 602, the apparatus 400 scans the PIUE (including an associated printed security feature) via the scanner 402 to generate scanned image data. The scanned image data is made up of pixel data that may be constituted by gray scale values and represents the PIUE as a set of scanning pixels. The scanned image data may be pre-processed by the processor 406 and/or stored in the memory 408.

Next is step 604, at which the processor 406 analyzes the scanned image data produced at step 602 to detect the gray scale level of each of a plurality of subsets of the scanning pixel data generated by the scanner 402 and/or stored in the memory 408. Each of these subsets corresponds to a respective one of the above-mentioned sample gray scale regions. From these detected gray scale levels, the processor is able to determine the respective shifts in levels in the pixel data for each of the sample regions from the original pixel data used to print the regions to the levels actually detected at the regions by the scanner 402. Using the detected shifts in gray scale levels, the processor derives a function which translates the original printing data gray scale levels into corresponding scanning pixel gray scale levels as detected by the scanner 402. This function may be referred to as a forward direction transformation, and definition of this transformation is indicated at step 606. As before, the function may be based on a known shape of curve for such functions and may be fitted to match the available data points for the sample regions, by utilizing a cubic spline process or the like. (In some embodiments, an inverse function may first be determined and the forward-direction transformation may be derived from the inverse function.) In some embodiments, the forward-direction transformation may be represented in the examination equipment as a look-up table stored in the memory 408.

Next, as indicated by step 608, the forward direction transformation is applied to the original printing pixel data that was stored in the examination apparatus to reflect the data originally used to print the security feature of the PIUE (assuming the PIUE to be authentic). For example, a look-up table generated at step 606 may be used to transform the original printing pixel data. Then, as indicated by step 610, the processor compares the transformed original printing pixel data with portions of the scanning pixel data which correspond to the security feature in the PIUE to determine whether the security feature in the PIUE (and hence the PIUE itself) is authentic. The transformation of the original printing pixel data prior to comparing it with the scanning pixel data that corresponds to the security feature of the scanned PIUE may compensate for shifts in pixel values due to aging of the PIUE, exposure to environmental conditions, equipment performance variations, etc., and so may reduce the likelihood that an authentic document will mistakenly be identified as counterfeit.

In some embodiments, steps 500-504 (FIG. 5) may be applied even in the case of a printed security feature that requires comparison with original printing pixel data. The resulting inverse transform may then be applied either to the entire scanning pixel data or only to the pixel data which corresponds to the printed security feature, and the inverse-transformed scanning pixel data which corresponds to the printed security feature may then be compared with the original printing pixel data (which has not been transformed) to determine whether the PIUE is authentic.

In general, the present invention may improve the performance of printed security feature schemes by compensating for the apparent (as-scanned-for-examination) variability of authentic original documents.

The words “comprise,” “comprises,” “comprising,” “include,” “including,” and “includes” when used in this specification and in the following claims are intended to specify the presence of stated features, elements, integers, components, or steps, but they do not preclude the presence or addition of one or more other features, elements, integers, components, steps, or groups thereof.

A number of embodiments of the present invention have been described. Nevertheless, it will be understood that various modifications may be made without departing from the spirit and scope of the invention. The present invention may be applied, for example, to verification of documents other than postage indicia. Other variations relating to implementation of the functions described herein can also be implemented. Accordingly, other embodiments are within the scope of the following claims.

What is claimed is:

1. A method of determining authenticity of a printed image, the method comprising the steps of:
(A) scanning the printed image, the printed image having a plurality of sample gray scale regions, the scanning producing pixel data that corresponds to the printed image;
(B) detecting a gray scale level of each of a plurality of subsets of the pixel data, each of said subsets corresponding to a respective one of said sample gray scale regions;
(C) using the detected gray scale levels to define an inverse transformation;
(D) applying the inverse transformation to the pixel data; and
(E) processing the inverse-transformed pixel data to detect a security feature of the printed image.

2. The method according to claim 1, wherein the security feature is a watermark.

3. The method according to claim 1, wherein the plurality of sample gray scale regions includes three regions, each having a different gray scale level from the other regions.

4. The method according to claim 3, wherein the sample gray scale regions are in the form of a sequence of rectangular regions.

5. The method according to claim 1, wherein the inverse transformation is represented in the form of an inverse look-up table.

6. The method according to claim 1, wherein the printed image is part of a postage meter indicium.

7. A method of determining authenticity of a printed image, the method comprising the steps of:
(A) providing first pixel data representative of a security feature included in the printed image;
(B) scanning the printed image, the printed image having a plurality of sample gray scale regions, the scanning producing second pixel data that corresponds to the printed image;
(C) detecting a gray scale level of each of a plurality of subsets of the second pixel data, each of said subsets corresponding to a respective one of said sample gray scale regions;
(D) using the detected gray scale levels to define a transformation;
(E) applying the transformation to the first pixel data; and
(F) comparing the transformed first pixel data to a portion of the second pixel data.

8. The method according to claim 7, wherein the security feature is a watermark.

9. The method according to claim 7, wherein the security feature is a copy detection pattern.

10. The method according to claim 7, wherein the plurality of sample gray scale regions includes three regions, each having a different gray scale level from the other regions.

11. The method according to claim 10, wherein the sample gray scale regions are in the form of a sequence of rectangular regions.

12. The method according to claim 7, wherein the transformation is represented in the form of a look-up table.

13. The method according to claim 7, wherein the printed image is part of a postage meter indicium.

14. A method comprising:
(A) providing a mailpiece; and
(B) applying a postage meter indicium to the mailpiece, the indicium including a pictorial image, a security feature and a sequence of at least three rectangular sample gray scale regions adjacent to the pictorial image, each sample gray scale region having a substantially uniform gray scale tone and each having a respective gray scale level that is substantially different from the other sample gray scale regions.

15. The method according to claim 14, wherein the security feature is a watermark in the pictorial image.

16. The method according to claim 14, wherein the applying includes printing the indicium on the mailpiece.

17. A mailpiece having a postage meter indicium thereon, the indicium including a pictorial image, a security feature and a sequence of at least three rectangular sample gray scale regions adjacent to the pictorial image, each sample gray scale region having a substantially uniform gray scale tone and each having a respective gray scale level that is substantially different from the other sample gray scale regions.

18. The mailpiece according to claim 17, wherein the security feature is a watermark in the pictorial image.
